(19) United States
(12) Patent Application Publication
(10) Pub. No.: US 2009/0248565 A1
(43) Pub. Date: Oct. 1, 2009

(54) Systems and Methods for Creating and Pricing Search Advertising Derivatives

(76) Inventor: Kai Chuang, Cambridge, MA (US)

Correspondence Address: CHOATE, HALL & STEWART LLP, TWO INTERNATIONAL PLACE, BOSTON, MA, 02110, US

(21) Appl. No.: 12/411,007

(22) Filed: Mar. 25, 2009

Related U.S. Application Data
(60) Provisional application No. 61/039,278, filed on Mar. 25, 2008.

(51) Int. Cl. G06Q 40/00; G06F 17/30; G06Q 10/00; G06Q 30/00

(52) U.S. Cl. 705/37; 707/3; 705/400; 707/E17.014; 707/E17.044

(57) ABSTRACT

Systems and methods for producing, valuing, and trading derivatives of advertisement inventory are described. The derivative instruments allow buyers and sellers of advertisement inventory to transact a right or obligation to purchase and receive advertisement inventory at a specified price as well as reselling and trading this right or obligation with other parties. In one embodiment, a derivative instrument allows the buyer to purchase the right, but not the obligation, to receive advertisement inventory on a later date at a pre-determined price. In another embodiment, a buyer of advertising inventory buys this right at a price as calculated by using the Merton options formula, which can estimate relevant parameters such as price history, price volatility, seasonality, and correlation with prices of other advertising inventory.

### FIELD OF THE INVENTION

The present disclosure is related to advertising. More specifically, the disclosure relates to developing derivative advertisement instruments and associated methods to price and trade said derivative instruments.

### BACKGROUND OF THE INVENTION

The advent of search advertising—displaying ads in response to search strings, or keywords, entered by a user in a search engine (e.g., Google, Yahoo)—created marketplaces where advertising keywords are bought and sold. Buyers (e.g., advertisers) bid on how much they are willing to pay for a given keyword, while sellers (e.g., Google) employ complex algorithms that use bid prices, among other considerations, to deliver ads alongside search results.

The use of derivatives could be traced to ancient times, when farmers who want to protect themselves against price fluctuations before harvest, would negotiate contracts with buyers upfront to deliver the harvest at a pre-determined price. In general, derivatives can be used as a means to transfer risk from those who want to eliminate risk to those who want to bear risk, thereby making markets more efficient. More recently, the application of derivatives in finance has transformed financial markets. Former U.S. Federal Reserve Board Chairman Alan Greenspan made the following comments regarding derivatives on Mar. 19, 1999, “By far the most significant event in finance during the past decade has been the extraordinary development and expansion of financial derivatives . . . these new financial instruments are an increasingly important vehicle for unbundling risks. These instruments enhance the ability to differentiate risk and allocate it to those investors most able and willing to take it. This unbundling improves the ability of the market to engender a set of product and asset prices far more calibrated to the value preferences of consumers than was possible before derivative markets were developed. The product and asset price signals enable entrepreneurs to finely allocate real capital facilities to produce those goods and services most valued by consumers, a process that has undoubtedly improved national productivity growth and standards of living.” Broadly speaking, some of the most basic types derivatives can be categorized as futures, forwards, or options. More specifically, futures are standardized contracts that allow the holder of the contract to buy or sell the underlying at a pre-determined price some time in the future. Forwards are like futures contracts, except they can be customized in terms of price, contract size, expiration date, as well as other contract terms. Options give the holder the right, but not obligation, to buy or sell the underlying at a pre-determined price some time in the future.

### SUMMARY OF THE INVENTION

An auction-based system may be profitable for advertisement sellers because buyers are almost always paying near their maximum willingness to pay as the going, or spot, price is determined by supply and demand at each moment in time. However, other factors such as seasonality can also influence the going price of keywords. For example, the going price for keyword “flowers” is much higher during the week leading up to Mother's Day. Knowing this effect, a florist who wishes to run Mother's Day advertisements based on the keyword “flowers” might want to lock-in “flowers” at a pre-determined price upfront, rather than paying the going price during the week before Mother's Day. Of course, the actual going price could be higher (or lower) than the pre-determined price. The physical construct for such a possibility is derivatives based on advertisement inventory. In particular, numerial computations involving historical price patterns and relationships with associated factors can be used to estimate the pre-determined price as well as how much the lock-in might be worth.

In one aspect, a method to produce, value, and trade derivatives of advertisement inventory is shown and described. The derivative instruments allow buyers and sellers of advertisement inventory to transact a right or obligation to purchase and receive advertisement inventory at a specified price as well as reselling and trading this right or obligation with other parties.

In one embodiment, a derivative instrument allows the buyer to purchase the right, but not the obligation, to receive advertisement inventory on a later date at a pre-determined price. In another embodiment, a buyer of advertising inventory buys this right at a price as calculated by using formulas such as Merton, Black-Scholes, binomial, Monte Carlo, or Black, to estimate relevant parameters such as price history, price volatility, seasonality, and correlation with prices of other advertising inventory. Later, if the going price is higher than the pre-determined price, the buyer pays the pre-determined price for delivery of the advertisement inventory. Conversely, if the going price is lower than the pre-determined price, the buyer can let the right to purchase expire, and buy the advertisement inventory at the going price.

In yet another embodiment, a derivative instrument allows the buyer to purchase advertisement inventory to be received on a later date at a pre-determined price. In one embodiment of this invention, buyer of advertising inventory pays the seller a price as calculated by the Ornstein-Uhlenbeck formula, which can estimate effects of parameters such as price history, price volatility, mean-reversion rate, seasonality, and correlation with prices of other advertising inventory. In other words, certain embodiments can be used as a way to calculate the discount for buying advertising up front.

In further aspects, the derivative instruments can also to resold or traded with other parties such as speculators. In one embodiment, obligations to receive advertising inventory on a specified date are standardized with respect to attributes like quality, volume, delivery time, and target geography, and resold or traded in a marketplace like the Chicago Board of Trade or Google. Specifically, speculators who think the futures price of said advertising inventory will increase over time can buy futures now and sell them later at a profit. Similarly, speculators who think the futures prices of said advertising inventory will decrease over time can sell futures now and buy them later for a profit.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 depicts an embodiment of a futures transaction based on price.

FIG. 2 depicts an embodiment of a futures transaction based on quantity.

FIG. 3 depicts an embodiment of an options transaction.

FIG. 4 depicts an embodiment of a futures transaction based on inventory

FIG. 5 depicts an embodiment of a derivatives marketplace/exchange.

FIG. 6 depicts an embodiment of the spot price history for keywords “flowers” and “mothers day”.

FIG. 7 depicts an embodiment of estimated and actual spot prices for the keyword “flowers”.

### DETAILED DESCRIPTION

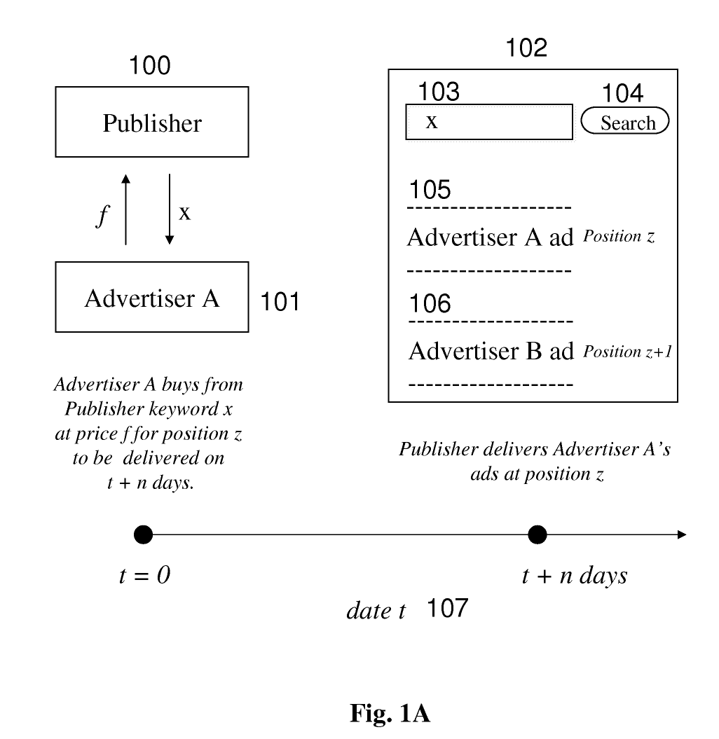

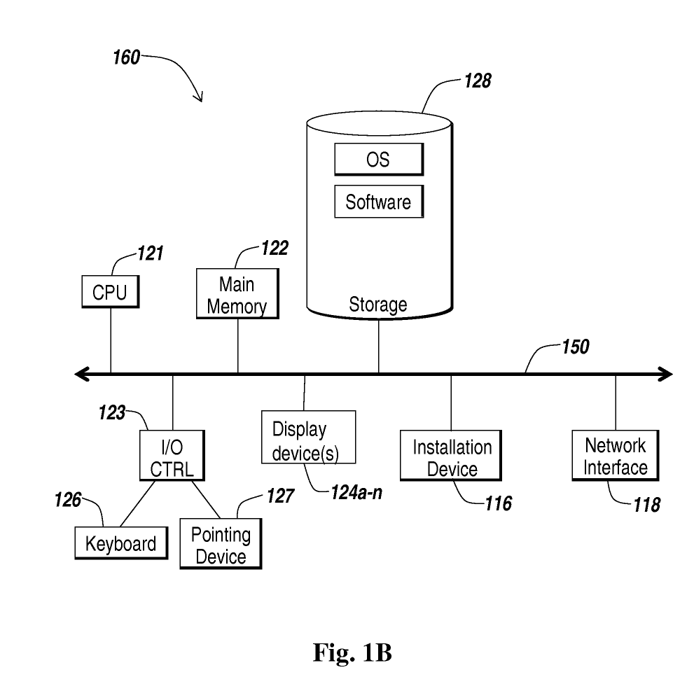

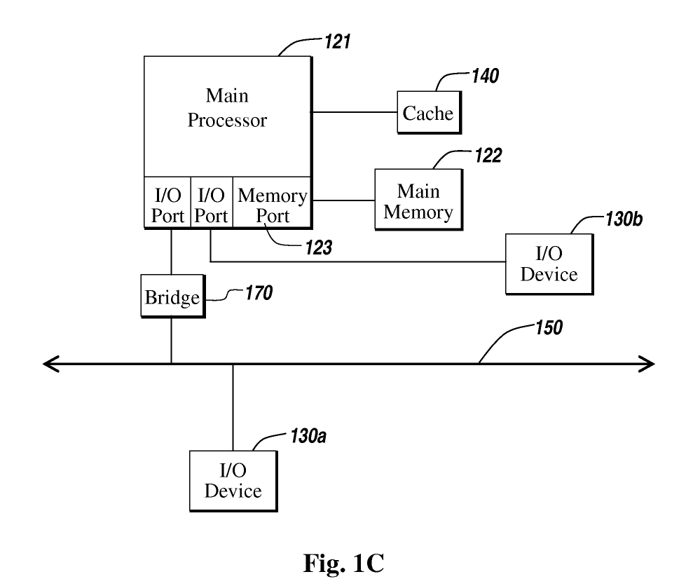

Referring now to FIG. 1 there is shown a Publisher 100 (e.g. Google), an Advertiser A 101, a search results page 102 having a search field 103 containing keyword x, search button 104, and advertisements Advertiser A ad 105 and Advertiser B ad 106. Additionally, in FIG. 1 there is shown a timeline of events 107. In more detail, still referring to FIG. 1, Advertiser A 101 pays Publisher 100 price f for keyword x to have Advertiser A ad 105 delivered on search results page 102 at position z on date t+n 107. On day t+n, Publisher 100 displays Advertiser A ad 105 at position z on search results page 102. Publisher 100 may provide an advertising platform where keywords and advertisements can be bought and sold. Additionally, Publisher 100 may also provide a search engine platform where keyword searches will result in the display of relevant advertisements. Finally, the advertising platform may function as a transparent marketplace and not artificially set prices. In some embodiments, the applications of derivatives to advertisements may be facilitated or implemented via computing devices. For example, a derivatives market may be operated over the Internet, such that participants in the market can buy or sell the derivatives online. Or for example, computing devices may be used to calculate prices or otherwise value derivatives. Or for example, computing devices may be used to display aspect of a derivatives market including, without limitation, prices, volume, volatility, and availability. FIGS. 1B and 1C depict block diagrams of a computing device 160 useful for practicing an embodiment of the client 102 or a server 106. As shown in FIGS. 1B and 1C, each computing device 160 includes a central processing unit 121, and a main memory unit 122. As shown in FIG. 1B, a computing device 160 may include a visual display device 124, a keyboard 126 and/or a pointing device 127, such as a mouse. As shown in FIG. 1C, each computing device 160 may also include additional optional elements, such as one or more input/output devices 130a-130b (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 160 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 160 in which the processor communicates directly with main memory 122 via a memory port 123. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 communicates directly with I/O device 130b via HyperTransport, Rapid I/O, or InfiniBand. FIG. 1C also depicts an embodiment in which local busses and direct communication are mixed: the processor 121 communicates with I/O device 130a using a local interconnect bus while communicating with I/O device 130b directly.

The computing device 160 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs or portions thereof. The computing device 160 may further comprise a storage device, such as one or more hard disk drives or redundant arrays of independent disks, Flash memory, or EEPROMs, for storing an operating system and other related software, and for storing application software programs. Optionally, any of the installation devices 116 could also be used as the storage device. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device 160 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET, ADSL, SDSL), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 160 communicates with other computing devices 160′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 160 to any type of network capable of communication and performing the operations described herein.

A wide variety of I/O devices 130a-130b may be present in the computing device 160. Input devices include keyboards, mice, trackpads, trackballs, microphones, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 160. In still other embodiments, the computing device 160 may provide USB connections to receive handheld USB storage devices such as the USB Flash Drive line of devices manufactured by Twintech Industry, Inc. of Los Alamitos, Calif.

In some embodiments, the computing device 160 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 160. For example, the computing device 160 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 160 may include multiple video adapters, with each video adapter connected to one or more of the display devices 124a-124n. In some embodiments, any portion of the operating system of the computing device 160 may be configured for using multiple displays 124a-124n. In other embodiments, one or more of the display devices 124a-124n may be provided by one or more other computing devices, such as computing devices 100a and 100b connected to the computing device 160, for example, via a network. These embodiments may include any type of software designed and constructed to use another computer's display device as a second display device 124a for the computing device 160. One ordinarily skilled in the art will recognize and appreciate the various ways and embodiments that a computing device 160 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 160 of the sort depicted in FIGS. 1B and 1C typically operates under the control of operating systems, which control scheduling of tasks and access to system resources. The computing device 160 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, and WINDOWS VISTA, all of which are manufactured by Microsoft Corporation of Redmond, Wash.; MACOS, manufactured by Apple Computer of Cupertino, Calif.; OS/2, manufactured by International Business Machines of Armonk, N.Y.; and Linux, an open source operating system distributed by, among others, Red Hat, Inc., or any type and/or form of a Unix operating system, among others.

The computer system 160 can be any workstation, desktop computer, laptop or notebook computer, server, handheld computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. For example, the computer system 160 may comprise a device of the IPOD family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED or NINTENDO REVOLUTION device manufactured by Nintendo Co., Ltd., of Kyoto, Japan, or an XBOX or XBOX 360 device manufactured by the Microsoft Corporation of Redmond, Wash.

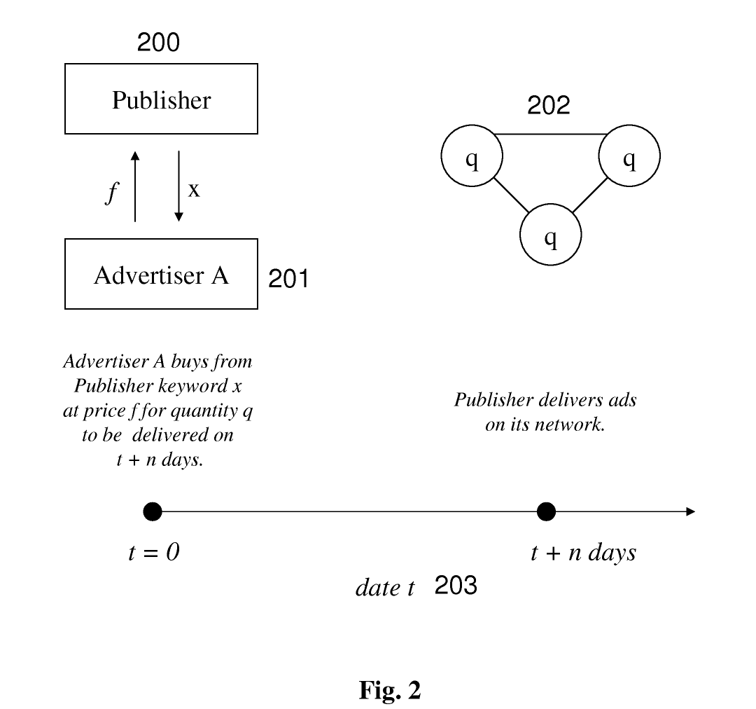

Referring now to FIG. 2, there is shown a Publisher 200, an Advertiser A 201, a network of online properties 202, and a timeline 203. In more detail, still referring to FIG. 2, Advertiser A 201 pays Publisher 200 price f for keyword x at quantity q on date t+n 203. On day t+n, Publisher 200 delivers ads by Advertiser 201 in quantity q on Publisher's network 202.

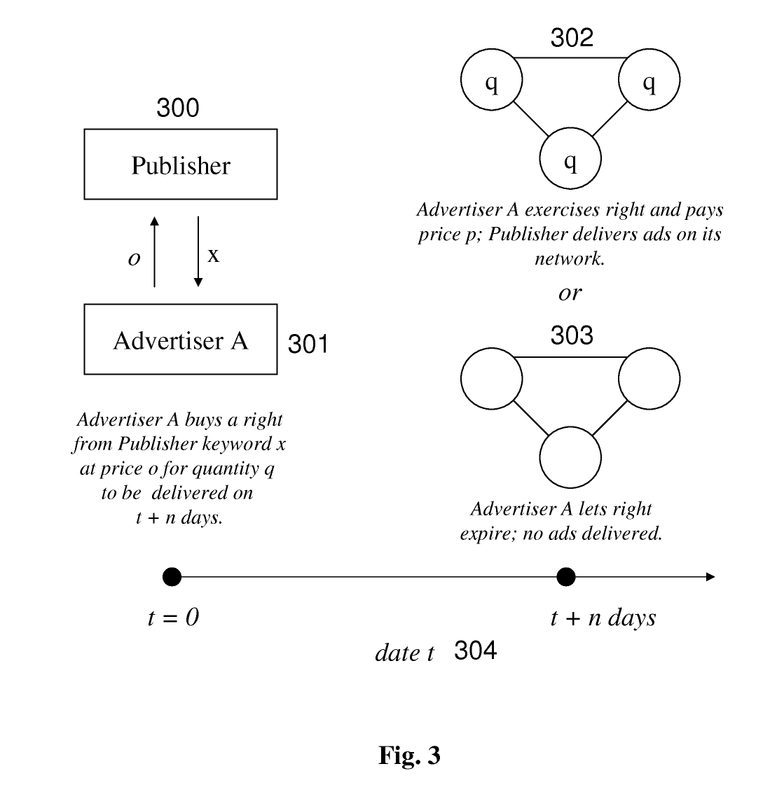

Referring now to FIG. 3, there is shown a Publisher 300, an Advertiser A 301, a network of online properties 302, a network of online properties 303, and a timeline 304. In more detail, still referring to FIG. 3, Advertiser 301 pays Publisher 300 price o for the right to buy keyword x at price p and quantity q on date t+n 304. On day t+n, Advertiser 301 could either exercise its right, and buys keyword x at price p and quantity q. Subsequently, Publisher 300 delivers ads in quantity q on Publisher 300's network 302. Alternatively, Advertiser 301 could do nothing, in which case no ads will be delivered.

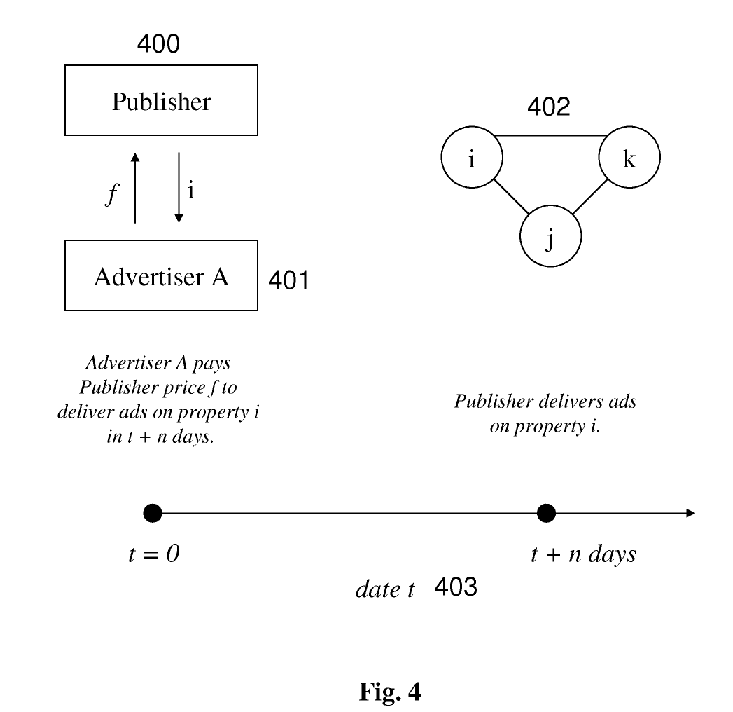

Referring now to FIG. 4, there is shown a Publisher 400, an Advertiser A 401, a network of online properties 402, and a timeline 403. In more detail, still referring to FIG. 4, Advertiser A 401 can pay Publisher 400 price f to advertise on property i on date t+n 403. In this scenario, no keywords are involved; Advertiser A 401 is buying inventory directly from Publisher 400.

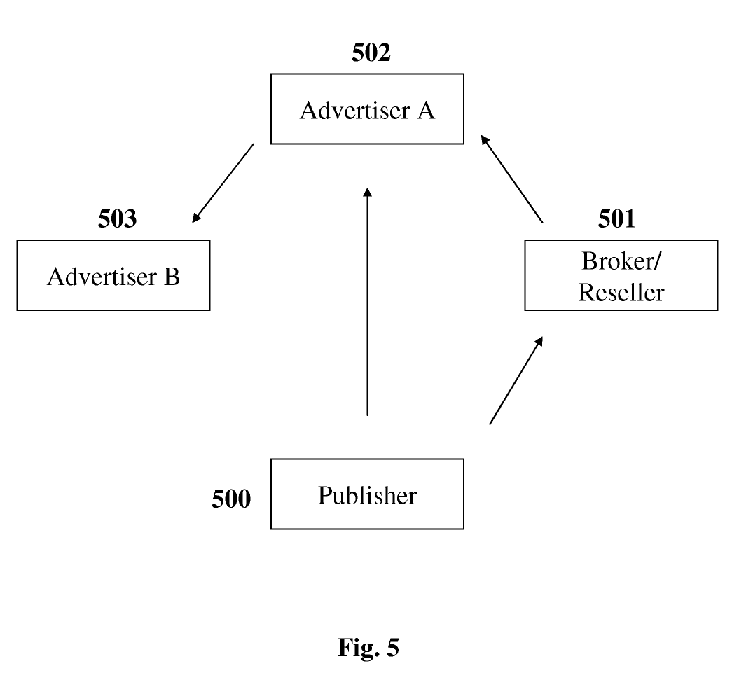

Referring now to FIG. 5, there is shown a Publisher 500, a Broker/Reseller 501, an Advertiser A 502, and Advertiser B 503. In more detail, Publisher 500 can sell a derivative instrument to Broker/Reseller 501. In turn, Broker/Reseller 501 can resell to Advertiser A 502. In turn, Advertiser 502 can resell the derivative instrument to Advertiser 503. An electronic derivatives exchange or marketplace, where trading systems provide bid/ask information, can be used to facilitate these transactions.

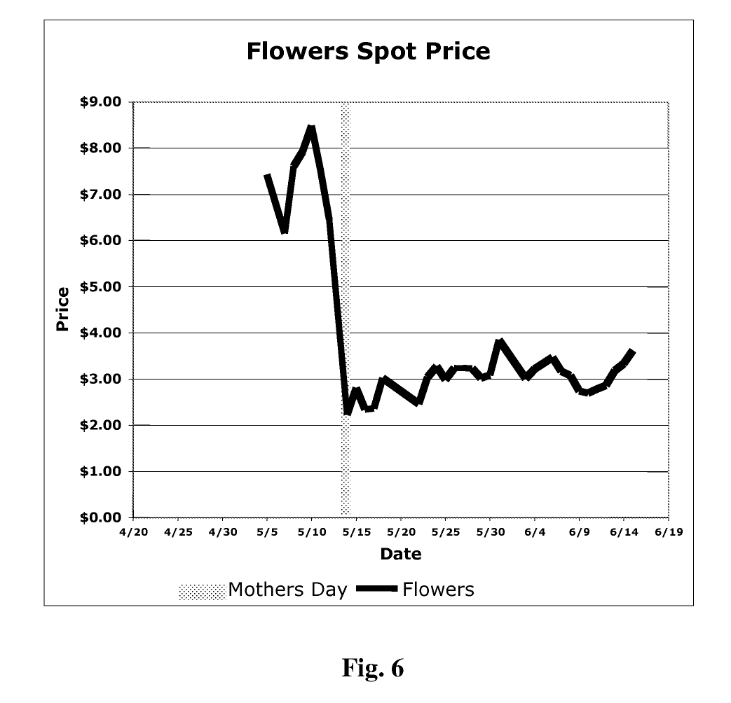

Referring now to FIG. 6 there is shown a graph of spot prices for keywords Flowers 600 and Mothers Day 601. In more detail, the spot price for keyword Flowers 600 is seen to fluctuate between dates May 5 and Jun. 14, achieving the highest price for this period on May 10.

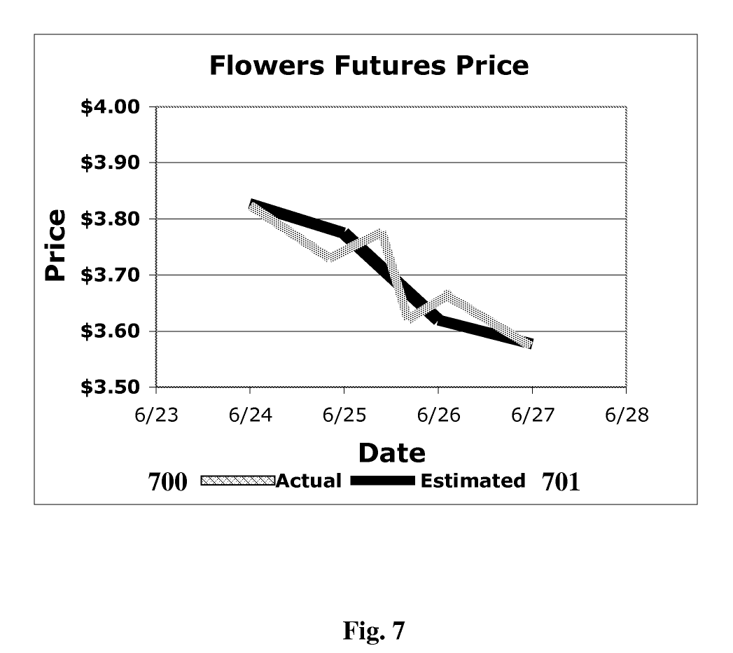

Referring now to FIG. 7 there is shown a graph of estimated spot price 701 and actual spot price 700 for keyword Flowers between Jun. 24 and Jun. 27. In more detail, the estimated spot price 701 can be determined by applying any number of financial models on historical spot price data. For example, the Ornstein-Uhlenbeck model can be used account for volatility and mean-reversion rate of historical prices. With an estimated future spot price, it would also be possible to calculate a discount off the future spot price for immediate payment. Furthermore, instruments derived from the underlying advertisement inventory can extend beyond keywords to radio and television timeslots, or billboard space.

Potential advantages of creating derivative markets for advertisements include, without limitation, increasing the efficiency of the market for advertisements, increasing the number of participants in the market for advertisements, smoothing out revenue for publishers and market makers, and lowering the price for consumers. Specifically, the use of derivatives allows the allocation of price risk to those who want to bear the risk, thereby bringing in new market participants and making the market more efficient. Additionally, publishers selling forward contracts and options can smooth out their revenue streams in spite of seasonality effects, thereby resulting in better management of working capital, for example. Finally, the derivatives would likely result in a lower fee paid by individual advertisers to publishers that could result in savings passed on to consumers. At the same time, the derivatives can also generate greater revenues for publishers by increasing the number of market participants.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A method of purchasing advertising derivatives, the method comprising utilizing a suitably programmed computer to perform the steps of:
identifying, by an advertiser utilizing a client agent, a keyword stored in a memory element associated with a computing device, the keyword related to an advertisement;
identifying, by the advertiser utilizing the client agent, a future publication time to publish the advertisement;
transmitting, by the client agent over a network to a server agent, a request to purchase an option to purchase publication, responsive to a search for the keyword, of the advertisement at the future publication time;
receiving, by the client agent over the network from the server agent, an offer to purchase for a first price the option to purchase publication, responsive to a search for the keyword, of the advertisement at the future publication time for a second price, wherein the first price and the second price are determined by the server agent; and
purchasing, by the advertiser utilizing the client agent, the option to purchase publication, responsive to a search for the keyword, of the advertisement at the future publication time for the price determined by the server agent.

2. The method of claim 1, wherein identifying a keyword related to an advertisement further comprises performing a natural language search on the advertisement.

3. The method of claim 1, wherein identifying a keyword related to an advertisement further comprises selecting from a database stored in a memory element associated with a computing device a keyword designated as relating to the advertisement.

4. The method of claim 1, wherein identifying a future publication time to publish the advertisement further comprises identifying a future publication time, responsive to the content of the advertisement.

5. The method of claim 1, wherein identifying a future publication time to publish the advertisement further comprises identifying a future publication time, responsive to an historical price data retrieved from a memory element associated with a computing device.

6. The method of claim 5, wherein identifying a future publication time, responsive to the historical price data, further comprises identifying a time associated with a peak price in the historical price data.

7. The method of claim 1, wherein purchasing at the option to purchase publication of the advertisement further comprises immediately purchasing the option.

8. The method of claim 1, wherein purchasing at the option to purchase publication of the advertisement further comprises bidding at an auction by the advertiser utilizing the client agent.

9. The method of claim 1, further comprising the advertiser reselling a purchased option to a second advertiser.

10. A method of selling advertising derivatives, the method comprising utilizing a suitably programmed computer to perform the steps of:
receiving, by a server agent, a request from a client agent to purchase an option to purchase publication of an advertisement, the request including a keyword associated with the advertisement and a future publication time;
retrieving, by the server agent, an historical price data for the keyword from a memory element associated with a computing device;
determining, by the server agent and responsive to the historical price data, an estimated volatility of price data;
determining, by the server agent, a first price for publishing the advertisement at the future publication time, responsive to the historical price data and the estimated volatility of price data;
determining, by the server agent, a second price for an option to purchase publication of the advertisement at the first price at the future publication time, wherein the second price is determined responsive to the first price and proportional to the time until the future publication time and the estimated volatility of price data; and
transmitting, by the server agent, an offer to the client agent to purchase for the second price the option to purchase publication, responsive to a search for the keyword, of the advertisement at the future publication time for the first price.

11. The method of claim 10, wherein determining a first price further comprises determining an estimated market price for publication of the advertisement at the future publication time.

12. The method of claim 10, wherein determining the first price further comprises determining the first price based on the estimated volatility of price data, determined responsive to seasonality of the historical price data.

13. The method of claim 10, wherein determining the first price further comprises determining the first price responsive to the amount of available inventory, the historical price data, and the estimated volatility of price data.

14. The method of claim 10, wherein determining a second price further comprises determining a value of a call or put option proportional to the first price multiplied by a base of a natural logarithm (e) raised to a power of the product of the time until the future publication time and a continuously compounded interest rate.

15. A system for purchasing advertising derivatives, the system comprising:
a computing device;
a memory element associated with the computing device, containing a keyword related to an advertisement;
computer-readable program means for identifying:
a keyword stored in a memory element associated with a computing device, the keyword related to an advertisement, and
a future publication time to publish the advertisement;
computer-readable program means for transmitting a request to purchase an option to purchase publication, responsive to a search for the keyword, of the advertisement at the future publication time;
computer-readable program means for receiving an offer to purchase for a first price the option to purchase publication, responsive to a search for the keyword, of the advertisement at the future publication time for a second price, wherein the first price and the second price are determined by the server agent; and
computer-readable program means for purchasing the option to purchase publication, responsive to a search for the keyword, of the advertisement at the future publication time for the price determined by the server agent.

16. A system for selling advertising derivatives, the system comprising:
a computing device;
a memory element associated with the computing device, containing an historical price data for a keyword related to an advertisement;
computer-readable program means for receiving a request from a client agent to purchase an option to purchase publication of the advertisement, the request including the keyword associated with the advertisement and a future publication time;
computer-readable program means for determining:
responsive to the historical price data, an estimated volatility of price data,
a first price for publishing the advertisement at the future publication time, responsive to the historical price data and the estimated volatility of price data, and
a second price for an option to purchase publication of the advertisement at the first price at the future publication time, wherein the second price is determined responsive to the first price and proportional to the time until the future publication time and the estimated volatility of price data; and
computer-readable program means for transmitting an offer to the client agent to purchase for the second price the option to purchase publication, responsive to a search for the keyword, of the advertisement at the future publication time for the first price.
